(19) United States
(12) Patent Application Publication
(10) Pub. No.: US 2025/0144880 A1
(43) Pub. Date: May 8, 2025

(54) ADDITIVE MANUFACTURING OF A THIN, ANGLED COMPONENT STRUCTURE

(71) Applicant: Siemens Energy Global GmbH & Co. KG, Munich, Bayern (DE)

(72) Inventors: Timo Heitmann, Berlin (DE); Jan Pascal Bogner, Berlin (DE)

(73) Assignee: Siemens Energy Global GmbH & Co. KG, Munich, Bayern (DE)

(21) Appl. No.: 18/835,497

(22) PCT Filed: Jan. 20, 2023
(86) PCT No.: PCT/EP2023/051384

§ 371 Date: Aug. 2, 2024

(30) Foreign Application Priority Data
Feb. 18, 2022 (DE) 10 2022 201 696.3

(51) Int. Cl. B29C 64/273; B22F 10/28; B22F 10/36; B22F 12/43; B22F 12/46; B29C 64/153; B29L 23/00; B33Y 10/00; B33Y 80/00

(52) U.S. Cl. CPC B29C 64/273; B22F 10/28; B22F 10/36; B22F 12/43; B22F 12/46; B29C 64/153; B33Y 10/00; B29K 2995/0097; B29L 2023/22; B33Y 80/00

(57) ABSTRACT

A method for the additive manufacturing of a thin, angled component structure. The method includes adjusting irradiation parameters from a first layer to a following layer in the construction direction, wherein a line energy and/or a scanning speed is changed for the irradiation of the following layer in order to change a melt pool width of an irradiation path for the following layer, and shifting an irradiation path for the following layer from the first layer in such a way that an angled edge is formed on a side of the component structure being formed opposite a movement direction. A correspondingly manufactured component and a computer program product are provided.

### CROSS REFERENCE TO RELATED APPLICATIONS

This application is the US National Stage of International Application No. PCT/EP2023/051384 filed 20 Jan. 2023, and claims the benefit thereof, which is incorporated by reference herein in its entirety. The International Application claims the benefit of German Application No. DE 10 2022 201 696.3 filed 18 Feb. 2022.

### FIELD OF INVENTION

The present invention relates to a method for additive manufacturing, in particular powder bed-based manufacturing, of a thin, angled, thin-wall or chamfered component structure. Furthermore, a correspondingly produced component and a corresponding computer program product are the subjects of the present invention.

The relevant component is preferably provided for use in the hot gas path of a gas turbine. For example, the component relates to a component part to be cooled, having a thin-walled or delicate design. In an alternative to that or in addition, the component can be a component part for use in the automotive industry or in the aeronautical sector.

### BACKGROUND OF INVENTION

Design and material properties of high-performance machine component parts are the subject matter of on-going developments, in order to increase or expand functionalities and/or fields of use of the corresponding components during use. In heat engines, especially gas turbines, developments frequently target ever higher use temperatures. For example, in order to meet the challenges of changing industrial requirements, the developments furthermore seek the implementation of complex geometric features with ever greater contour fidelity and surface quality. For example, this can in turn improve a cooling performance of the components.

Additive manufacturing (AM) methods, colloquially also referred to as 3-D printing, for example comprise selective laser melting (SLM) or laser sintering (SLS) as powder bed method, or electron beam melting (EBM). In particular, additive manufacturing methods were found to be particularly advantageous for components with complicated designs, for example labyrinthine structures and/or lightweight structures. In particular, additive manufacturing is advantageous as a result of a particularly short chain of process steps since a production or manufacturing step for a component can largely be implemented on the basis of an appropriate CAD file and the choice of appropriate manufacturing parameters.

Component parts produced conventionally, for example by casting, are significantly inferior to those from the additive manufacturing route, for example in view of their shaping freedom and also with respect to the required throughput time and the high costs linked therewith, and in view of the manufacturing outlay. The production of gas turbine blades by means of the above-described powder bed-based methods (“LPBF” meaning laser powder bed fusion) advantageously allows the implementation of novel geometries or concepts which reduce the production costs or the buildup and throughput time, which optimize the production process and which for example are able to improve a thermal-mechanical design or resilience of the component parts.

The use of the additive LPBF method already makes it possible to produce complex and small geometries with great accuracy. The resolution limit or a minimal structure width or wall thickness is usually of the order of 120 μm to 200 μm in the case of conventional exposure strategies. In principle, the application of a pulse-modulated exposure strategy allows “structure thicknesses” to be implementable down to 100 μm. Primarily, this is achieved by a single track exposure.

It is standard practice to distinguish between an areal exposure (“hatching”) and a single track exposure. The respective scanning strategy is furthermore usually determined by the thickness defined by CAD (“computer-aided design”) by way of a CAM (“computer-aided manufacturing”) process.

### SUMMARY OF INVENTION

It is therefore a stated problem of the present invention to specify an improved or adjusted buildup and/or irradiation strategy for additive manufacturing, by means of which it is possible to reproduce particularly delicate, thin and/or angled component structures with improved contour and/or surface quality.

This problem is solved by the subject matter of the independent claims. Advantageous refinements are the subject matter of the dependent claims.

One aspect of the present invention relates to a method for additive manufacturing, in particular powder bed-based additive manufacturing, of a thin, angled or thin-walled component structure. Accordingly, the component to be produced may also comprise only one region with a thin wall, with a geometry that is widening out or coming together at an angle or conically or with a tapering geometry.

The method comprises adjusting irradiation parameters from a first layer in the manufacture of the component to a following (second) layer in the construction direction, with a line energy or irradiation power, in particular of a scanning laser or electron beam, and/or a scanning speed for the irradiation of the following layer being changed in order to change, i.e. in particular reduce or increase, a melt pool width of an irradiation or exposure path for the following layer.

The method furthermore comprises (simultaneously) shifting an irradiation path (perpendicular to the construction direction) for the following layer from the first layer in such a way that an angled edge is formed on a side of the component structure being formed opposite a movement direction.

The expression angular or “angled” should in this context predominantly mean that the corresponding edge makes an angle with the horizontal that is not equal to zero (less than) 90° over its course.

The said angled edge by preference denotes only one side of the component structure, and therefore for example a side of the component opposite the edge can run perpendicular or not at an angle.

The angled edge is a chamfer in one configuration.

Consequently, an adaptive irradiation strategy with process parameters adjusted layer-by-layer is specified, in particular in order to be able to produce very thin angled or thin-walled geometries by means of LPBF. In particular, the presented means allow a significant improvement in the contour fidelity of structures that vary in thickness along the construction direction, and furthermore a “stair-step” effect can advantageously be reduced or even entirely avoided.

The line energy, which can be varied over the laser power in particular, is reduced in one configuration. According to this configuration, the energy input in particular can be reduced, and a contour fidelity of the structure to be constructed additively can be improved.

The scanning speed is increased in one configuration. In particular, according to this configuration, energy introduced into the powder bed per unit time and space can be reduced in equivalent fashion.

In one configuration, the energy input for the production of the thin component structure is applied in pulsed or pulse-modulated fashion. By preference, the pulsed irradiation operation relates to a low-frequency range of between 1 kHz and 5 kHz, for example. This parameter and in particular the entire frequency range were found to be particularly advantageous for pulsed irradiation. In particular, this advantageously allows discrete solidification of individual melt pools between each laser pulse. In turn, this leads to a useful reduction of dynamic instabilities in the melt pool. Moreover, this yields advantages in respect of the irradiation time and hence the process efficiency.

In one configuration, an irradiation of the first layer forms a thicker component region than an irradiation of the following layer(s), with the component structure tapering in the construction direction.

In one configuration, the tapered component structure, in particular for the following layer(s), is irradiated exclusively by way of single tracks or individual irradiation vectors. Precisely no so-called “hatching” irradiation strategy is applied according to this configuration.

In one configuration, the angled or tapered component structure has a wall thickness of less than 250 μm.

In an alternative configuration, the irradiation of the aforementioned first layer forms a thin or thinner region than an irradiation of the following layer(s), and so the component structure according to this configuration widens along the construction direction.

A further aspect of the present invention relates to a component produced or to be produced accordingly, having a thin, “chamfered” component region or a component region tapering or widening in a construction direction, the component region being stair-step free in particular and of a style not reproducible by way of a conventional additive irradiation strategy. The advantages of the presented method of the invention are thus manifested directly in the structure advantages of the correspondingly produced component.

A further aspect of the present invention relates to a computer program or computer program product, for example as part of a numerical control instruction, comprising commands which, upon execution of the program by a device, for example for controlling the irradiation in an additive manufacturing apparatus, cause the said device to choose the line energy and/or the scanning speed and perform the production of the thin component structure accordingly.

For example, a CAD file or a computer program product can be provided or be present as (transitory or non-transitory) storage or reproduction medium, e.g. a memory card, a USB stick, a CD-ROM or DVD, or else in the form of a downloadable file from a server and/or in a network. The provision can furthermore be implemented for example in a wireless communications network by the transfer of an appropriate file with the computer program product. A computer program product can contain program code, machine code or numerical control instructions, such as G-code and/or other executable program instructions in general.

In one configuration, the computer program product relates to production instructions, according to which an additive production apparatus is controlled to produce the component, for example by way of CAM means by way of an appropriate computer program.

The computer program product can furthermore comprise geometry data and/or construction data in a data record or data format, for example in a 3-D format or as CAD files, or comprise a program or program code for providing these data.

Configurations, features and/or advantages relating presently to the method or the computer program (product) can further directly relate to the component structure, and vice versa.

As used herein, the expression “and/or”, when used in a series of two or more elements, means that each of the listed elements can be used on its own, or any combination of two or more of the listed elements can be used.

Further details of the invention are described below on the basis of the figures.

### BRIEF DESCRIPTION OF THE DRAWINGS

In the left region of the illustration, FIG. 1 shows a schematic sectional view of an exemplary tubular component structure. The right image portion shows a schematic perspective illustration of this structure. The lower region of the illustration depicts, in three partial views, the sectional planes B, C and D plotted in the left upper region.

FIG. 2 shows, inter alia, inventive details of a layer subdivision as reflected in the component structure of FIG. 1.

In the left-hand region of the view, FIG. 3 indicates a plan view of a production area or a corresponding irradiation pattern. The right-hand region of the illustration in FIG. 3 illustrates a schematic sectional view of a thin angled component structure (cf. likewise FIG. 1) with details according to the invention.

FIG. 4 illustrates the thin angled component region depicted to the right in FIG. 3, with further details according to the invention.

### DETAILED DESCRIPTION OF INVENTION

In the exemplary embodiments and figures, the same elements or elements with the same effect may be provided with the same reference signs in each case. The depicted elements and their proportions in relation to one another should not be considered to be true to scale as a matter of principle; instead, individual elements can be depicted with an exaggerated thickness or overly large, for reasons of better presentability and/or for a better understanding.

In powder bed-based additive manufacturing, a component structure is usually produced layer-by-layer on a build platform according to a specified geometry, by virtue of a previously applied powder layer being selectively fused and solidified by an irradiation device, in particular by a laser beam or electron beam.

The geometry of the component is usually defined by a CAD (“computer aided design”) file. After such a file has been read into the production apparatus, the process subsequently requires, at first, the definition of a suitable irradiation strategy, for example by CAM, whereby the component geometry is usually divided into the individual layers.

After each layer Lₙ, the build platform 101 is preferably lowered by a measure corresponding to the layer thickness L. The layer thickness is usually only between 20 μm and 40 μm, and so the entire process can easily comprise the selective irradiation of thousands to tens of thousands of layers. As a result of the energy input acting only very locally, high temperature gradients, for example 106 K/s or more, may arise in the process.

On the basis of an exemplary tubular component geometry, FIG. 1 indicates an at least partially conventional irradiation or scanning strategy. The upper left portion of the image indicates a cross section of the tube with a chamfer at the upper inner edge in particular. In the region of the chamfer, reference sign 11 indicates a component region 11 with correspondingly thin walls or a corresponding taper to a point. The hatching of the structure should furthermore clarify that the corresponding component 10 can largely be produced by an areal or hatching exposure.

In the plane of labeled section B, the wall thickness of the structure allows “hatching” in any case. By contrast, from the plane of section C, single track exposure with individual irradiation vectors (cf. reference sign Vₙ further below) may start since a minimal wall thickness (structure reproduction limit) might have been reached for this type of irradiation.

Further up in the (vertical) construction direction Z, sectional plane D therefore also has single track exposure. This results in a thinner wall thickness for the structure. A conventional additive irradiation strategy which does not have the advantages of the present invention cannot render or reproduce the shown chamfer or stair-step-free taper of the structure as shown in the illustration.

The upper right region of the illustration in FIG. 1 shows a schematic perspective view of the structure.

Three schematic perspective partial illustrations along the sections B-B, C-C and D-D are inserted (from left to right) in the lower region of FIG. 1.

The present invention now enables a solution of the above-described problem with an improved irradiation strategy according to the invention, in particular an adjusted choice of parameters, and an optimal arrangement of irradiation vectors.

In particular, the process according to the invention can be directed to the reproduction of structures, for example angled in the construction direction, with a wall thickness of 0.25 mm (250 μm) or less, exclusively by way of the irradiation of single tracks or individual irradiation vectors. Further, the method contains the adjustment of the line energy or irradiation power in each new layer for the purpose of reducing the melt pool width or dimension. At the same time, the exposure or irradiation path of the scan vector is shifted in order to obtain the defined external contour of the component.

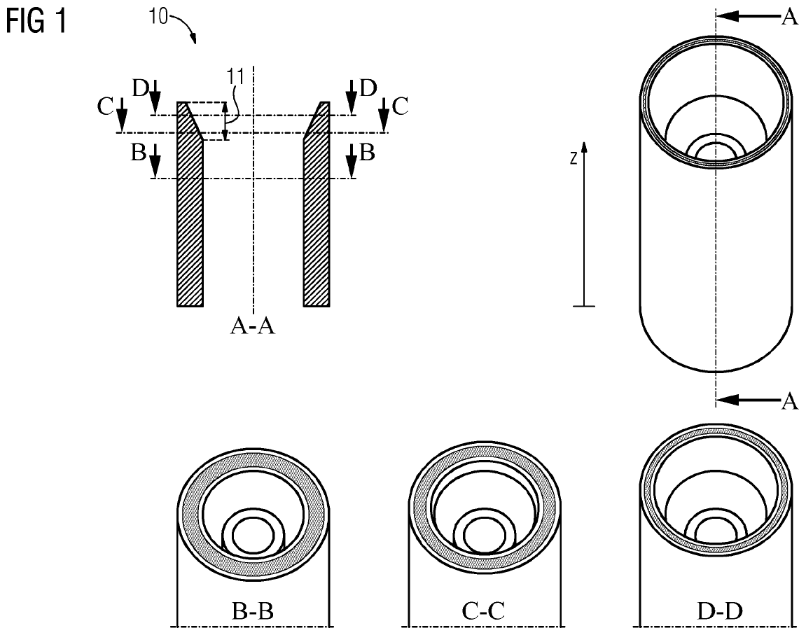

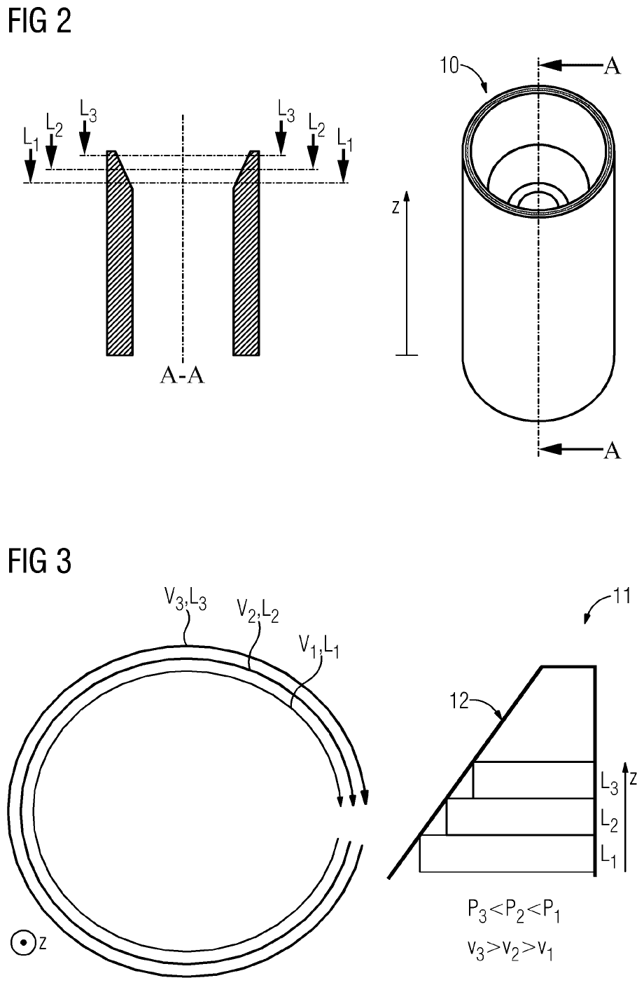

In particular, there is single track exposure in the layer in the construction direction Z which is the starting point for the construction of the angled features. A sectional plane associated with a first layer L₁ is labeled in FIG. 2 in this respect. As the construction continues to progress in the Z-direction, a subsequent, second layer L₂ is now selectively irradiated and solidified for the purpose of forming the taper setting-in in the component structure 11. Then, a further following (third) layer L₃ is implemented even further along the construction direction Z.

Without loss of general validity, significantly more layers Lₙ might naturally still be required to produce the thin, angled component structure-depending on inclination or predetermined profile of the angle or chamfer.

For the sake of clarity, the upper right part of the illustration in FIG. 2 once again shows a perspective view.

The left-hand part of FIG. 3 shows a plan view of a production surface or powder bed, and illustrates the irradiation vectors Vₙ for the circular contour of the component 10 which are associated with the section planes or their layers indicated above. For the uppermost plotted layer L₃, the vector V₃ in particular can be identified on the outside as an individual irradiation vector. In the center of the plan view, the irradiation vector V₂ for the representation of the second, central layer L₂ is shown in particular. Finally, the inner vector V₁ represents the lower depicted layer L₁.

In this context, the right-hand part of FIG. 3 shows the angled or chamfered profile 12 of the component structure 11 in enlarged fashion. It is possible to identify that even all layers L₁, L₂ and L₃ can be implemented as individual irradiation vectors, with however a melt pool or a melt pool width (cf. horizontal extent of the layers to the right in FIG. 3) being reduced as the construction progresses. In particular, this is implemented by way of an adjustment of the irradiation parameters.

In particular, a line energy or laser power P₂ of the second layer L₂ is chosen to be less than an energy P₁ of the first layer L₁. Conversely, a scanning speed v₂ of the second layer L₂ can additionally or alternatively be chosen to be greater than a scanning speed v₁ of the first layer L₁. In other words, the beam energy or laser power is reduced and/or a scanning speed is increased layer-by-layer in the construction direction. These parameters allow a particularly advantageous influencing or reduction of a melt pool width, as indicated by the layer applications depicted as rectangular. Furthermore, this is advantageously enabled while keeping the external geometry of the structure constant.

Additionally, the energy input is preferably in pulsed fashion in order to additionally reduce the extent of the melt pools during the production and ensure a high contour fidelity and surface quality of the component structure.

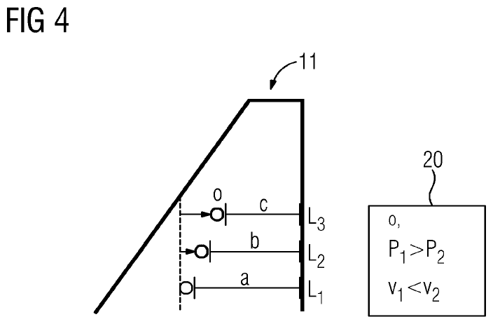

FIG. 4 illustrates a further element from the method according to the invention. In addition to the indicated parameter adjustment, the exposure vectors are preferably shifted in the direction of the (vertical) outer edge with increasing height in the Z-direction for the purpose of forming the chamfer or the angled thin profile of the structure 11 on one side. In particular, it is possible to identify that a distance a of the melt pool from the outer edge or edges of the component structure 11 is maintained for the first layer L₁. This distance preferably corresponds to a center-to-center distance or half a wall thickness or wall strength of the structure 11.

In the layer L₂ following the first layer L₁, the exposure vector V₂ is slightly shifted to the right, i.e. toward the outer edge, along the plotted arrow such that the plotted distance b is maintained. The same applies accordingly to the third depicted layer L₃, the melt pool center of which is shifted to the outside over the length or movement o such that the distance c can be maintained. Therefore, the following preferably applies: a>b>c.

FIG. 4 also schematically indicates a device 20, which for example might be configured as processor, computer, control unit or 3-D printer device and which according to the invention can have appropriate means for choosing the aforementioned parameters, in particular by way of CAM and their process-related implementation. In particular, the device 20 can be configured to execute computer programs and provide a computer program product according to the present invention.

An angled region of a thin component structure is advantageously reproduced with particular contour fidelity, dimensional accuracy and surface quality by way of the described “design rule” of the present invention.

Without loss of generality, a component structure for example widening in the construction direction can be reproduced by way of the advantages according to the invention—also unlike what was depicted in the above-described figures—, wherein the described parameters should then be correlated in precisely the opposite way for successive layers. For example, the introduced line energy can then be chosen to be particularly low for the purpose of forming a wider melt pool for a lower component layer and then be increased in the construction direction. In an alternative to that or in addition, what applies accordingly to the scanning speed is that the latter is reduced correspondingly in the construction direction. For such structures, the difficulty lies primarily but likewise in the implementation of the respectively thinner component region (lying further down).

The component can be a component of a turbo machine, for example a component for the hot gas path of a gas turbine. In particular, the component can denote a rotor blade or guide vane, a ring segment, a combustion chamber part or burner part, such as a burner tip, a frame, a shield, a heat shield, a nozzle, a seal, a filter, an opening or lance, a resonator, a stamp or an agitator, or a corresponding transition, insert, or a corresponding add-on part.

1. A method for additive manufacturing of a thin, angled component structure, comprising:
adjusting irradiation parameters (P, v) from a first layer (L1) to a following layer (L2, L3) in a construction direction (Z), a line energy (P) and/or a scanning speed (v) being changed for irradiation of the following layer (L2) in order to change a melt pool width of an irradiation path (V1, V2, V3) for the following layer (L2), and
shifting an irradiation path (V1, V2, V3) for the following layer (L2) from the first layer (L1) in such a way that an angled edge is formed on a side of the component structure being formed opposite a movement direction (o).

2. The method as claimed in claim 1,
wherein the line energy (P) is reduced and/or the scanning speed (v) is increased.

3. The method as claimed in claim 1,
wherein the angled edge is a chamfer.

4. The method as claimed in claim 1,
wherein an energy input for production of the component structure is applied in pulsed fashion.

5. The method as claimed in claim 1,
wherein an irradiation of the first layer (L1) forms a thicker region than an irradiation of the following layer (L2, L3), and wherein the component structure comprises a tapering component structure which tapers in the construction direction (Z).

6. The method as claimed in claim 5,
wherein an irradiation of the tapering component structure is implemented exclusively by way of single tracks (V2, V3).

7. The method as claimed in claim 5,
wherein the tapering component structure has a wall thickness of less than 250 μm.

8. The method as claimed in claim 1,
wherein an irradiation of the first layer forms a thinner region than an irradiation of the following layer, and wherein the component structure widens in the construction direction.

9. A component produced or producible according to the method as claimed in claim 1,
wherein the component has a thin, stair-step-free component region.

10. A non-transitory computer readable medium comprising:
commands stored thereon which, upon execution of the commands by a device, for controlling the irradiation in an additive manufacturing apparatus, cause the said device to choose the line energy (P) and/or the scanning speed (v) and perform the production of the component structure as claimed in claim 1.
